(19) United States
(12) Patent Application Publication
(10) Pub. No.: US 2026/0312120 A1
(43) Pub. Date: Oct. 8, 2026

(54) APPARATUS FOR MANUFACTURING SECONDARY BATTERY

(71) Applicant: SAMSUNG SDI CO., LTD., Yongin-si (KR)

(72) Inventors: Hee Taek LIM, Yongin-si (KR); Yong Seung SHIN, Yongin-si (KR)

(21) Appl. No.: 19/302,437

(22) Filed: Aug. 18, 2025

(30) Foreign Application Priority Data
Apr. 7, 2025 (KR) 10-2025-0044491

(51) Int. Cl. H01M 10/04; B21D 22/06

(52) U.S. Cl. CPC H01M 10/0481; B21D 22/06

(57) ABSTRACT

A secondary battery manufacturing apparatus may be configured to draw a case material for a secondary battery. The case material may have a recessed region. The secondary battery manufacturing apparatus may comprise an upper mold including a die pad configured to press the case material from above, a lower mold including a punch configured to press the case material from below, a blank holder mounted to the lower mold, the blank holder including a punch hole formed through the blank holder to receive the punch, the blank holder being configured to support the case material from below the case material, and a cam. The cam may include an upper cam mounted to the upper mold and having a first operating surface, a lower cam seated on the lower mold and having a second operating surface in contact with the first operating surface, and a sliding bar connected to the lower cam and configured to be linearly moved in a direction perpendicular to an operating direction of the upper cam by the lower cam.

### CROSS-REFERENCE TO THE RELATED APPLICATION

The present application claims priority to and the benefit of Korean Patent Application No. 10-2025-0044491, filed on Apr. 7, 2025, in the Korean Intellectual Property Office, the entire disclosure of which is incorporated herein by reference.

### BACKGROUND

### 1. Field

Aspects of some embodiments of the present disclosure relate to an apparatus for manufacturing a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable small electronic devices, such as smart phones, feature phones, notebook(laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Shapes of low-capacity secondary batteries may vary depending on mounting spaces in electronic devices. For example, secondary batteries applied to smartphones may have a square or rectangular shape when viewed from above. Secondary batteries applied to laptop computers may have various shapes such as a rectangular shape or an L-shape when viewed from above. One may encounter problems when forming a secondary battery having a recessed portion, such as an L-shaped secondary battery; for example, pressure applied to form the recessed portion of the case may stretch a material of the recessed portion, which may increase a risk of tearing of the material or a risk of other damage.

The information disclosed in this section is provided only for enhancement of understanding of the background of the disclosure and therefore it may contain information that does not constitute related (or the prior) art.

### SUMMARY

An aspect of the present disclosure is to provide a secondary battery manufacturing apparatus that improves processability of a case material for a secondary battery having a shape prone to damage.

These and other aspects and features of the present disclosure will be described in or will be apparent from the following description of some embodiments of the present disclosure.

A secondary battery manufacturing apparatus according to some embodiments of the present disclosure may be configured to draw a case material for a secondary battery. The case material may have a recessed region. The secondary battery manufacturing apparatus comprises an upper mold including a die pad configured to press the case material from above, a lower mold including a punch configured to press the case material from below, a blank holder mounted to the lower mold, the blank holder including a punch hole formed through the blank holder to receive the punch, the blank holder being configured to support the case material from below the case material, and a cam. The cam may include an upper cam mounted to the upper mold and having a first operating surface, a lower cam seated on the lower mold and having a second operating surface in contact with the first operating surface, and a sliding bar connected to the lower cam and configured to be linearly moved in a direction perpendicular to an operating direction of the upper cam by the lower cam.

In some embodiments, the sliding bar may include a stepped portion provided on a surface adjacent to an end of the sliding bar.

In some embodiments, the stepped portion may be provided on an upper surface of the sliding bar and may have a height difference C from the upper surface.

In some embodiments, the height difference C of the stepped portion from the upper surface corresponds to a thickness of the case material.

In some embodiments, the blank holder may include a sliding groove, which may be configured so that the sliding bar may be able to be inserted into the sliding groove of the blank holder.

In some embodiments, the punch may include an insertion groove, which may be configured so that the sliding bar may be able to be inserted into the insertion groove of the punch.

In some embodiments, the lower mold may further include a lower holder, which may be configured so that the punch may be able to be inserted in the lower holder. The punch may be mounted to the lower holder and may have an upper portion inserted into the punch hole formed through the blank holder.

In some embodiments, the lower mold may further include a plurality of blank holder springs configured to elastically support the blank holder from below the blank holder.

In some embodiments, the blank holder may be configured to be pressed and lowered as the upper mold descends.

In some embodiments, an upper portion of the punch may be configured to protrude upward through the punch hole as the blank holder descends.

In some embodiments, the insertion groove in the punch and the sliding groove in the blank holder may be configured to communicate with each other as the blank holder descends.

In some embodiments, the cam may further include a return spring having an end fixed to an inner side of the sliding groove in the blank holder and having an end coupled to the sliding bar.

In some embodiments, the return spring may be configured to expand as the sliding bar moves toward the blank holder and may be configured to exert a restoring force in a direction away from the blank holder.

In some embodiments, the upper mold may be fully lowered, wherein the case material may be disposed on the blank holder, and wherein the case material may be drawn between the punch and the die pad to form a recess and a flange.

In some embodiments, the upper mold may be fully lowered, and wherein the upper cam presses on the lower cam such that the sliding bar may be fully inserted into the insertion groove in the punch.

In some embodiments, the sliding bar may be fully inserted into the insertion groove in the punch, and wherein the stepped portion may be in contact with the flange of the case material and may be pressing on the flange.

In some embodiments, the flange being pressed by the stepped portion delimits the recessed region of the case material.

In some embodiments, the blank holder may further include an operating surface in a direction facing the lower cam, the operating surface corresponding with a plane perpendicular to a sliding direction of the sliding bar.

In some embodiments, in the blank holder, the sliding groove may be in communication with the operating surface.

In some embodiments, the upper mold may further include an upper holder having a pad receiving portion receiving the die pad and a die plate mounted under the upper holder, the die plate having a pad hole configured so that the die pad may be able to be inserted in the pad hole. The die pad and the punch may be fully engaged with each other inside the pad hole.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a schematic view showing an apparatus for manufacturing a secondary battery according to some embodiments of the present disclosure.

FIG. 2 is a view of a processed shape of a case material for a secondary battery according to some embodiments of the present disclosure.

FIG. 3 is a perspective view showing an external appearance of the mold shown in FIG. 1 according to some embodiments of the present disclosure.

FIG. 4 is a side view showing the mold of FIG. 3 before an upper mold of the mold is fully lowered according to some embodiments of the present disclosure.

FIG. 5 is a side view showing the mold of FIG. 3 once an upper mold of the mold is fully lowered according to some embodiments of the present disclosure.

FIG. 6 is a plan view of a lower mold according to some embodiments of the present disclosure.

FIG. 7 is a perspective view of the lower mold shown in FIG. 6 according to some embodiments of the present disclosure.

FIG. 8 is a rear perspective view of a sliding bar according to some embodiments of the present disclosure.

FIG. 9 is a front perspective view of a sliding bar according to some embodiments of the present disclosure.

FIG. 10 is a partial perspective view of a cam drive before the upper mold is fully lowered according to some embodiments of the present disclosure.

FIG. 11 is a partial perspective view showing a cam drive when the upper mold is fully lowered according to some embodiments of the present disclosure.

FIG. 12 is a partial perspective view showing a pre-operation state of a lower mold and a cam drive according to some embodiments of the present disclosure.

FIG. 13 is a view showing a damaged state of a case material for a secondary battery manufactured by a conventional manufacturing apparatus.

FIG. 14 is a view showing a case material for a secondary battery manufactured by the manufacturing apparatus according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, an apparatus for manufacturing a secondary battery according to some embodiments of the present disclosure will be described in detail with reference to the accompanying drawings. In the following description, a direction toward an upper mold is defined as an upward direction, and a direction toward a lower mold is defined as a downward direction.

FIG. 1 is a schematic view showing an apparatus for manufacturing a secondary battery according to some embodiments of the present disclosure.

A secondary battery manufacturing apparatus 1 according to some embodiments of the present disclosure may be a press machine. The press machine may include a mold 7 having a punch and a die. The press machine may be an apparatus that forms a case material 10 for a secondary battery into a predetermined shape by placing the case material 10 between the punch and the die and by then applying pressure to the case material 10 in a vertical direction. This manufacturing process may be referred to as a deep drawing process.

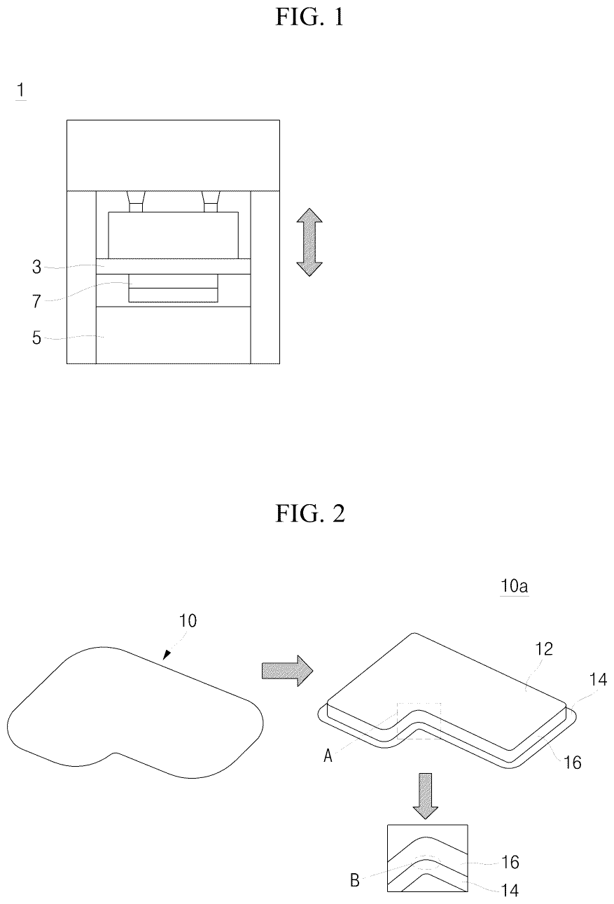

FIG. 2 is a view of a processed shape of a case material for a secondary battery according to some embodiments of the present disclosure.

The case material 10 for a secondary battery may be processed to form half of a case. The case material 10 for a secondary battery may be provided as a plate having an approximately L-shape in order to form an L-shaped case for a secondary battery when viewed in plan view (when viewed from above). The case material 10 for a secondary battery may be pressed by the secondary battery manufacturing apparatus 1 to be deformed into a shape having a recess 12 and a flange 14 (hereinafter referred to as a first case). The first case 10a may be provided in a pair of first cases 10a, and the pair of first cases 10a may form a complete case for a secondary battery. The recess 12 may serve as an accommodation space in which an electrode assembly is accommodated. A portion pushed outward by pressure applied to form the recess 12 may become the flange 14. The flange 14 may serve as a joint portion for coupling with another case material having a symmetrical structure to form a complete case. In some embodiments, if a pair of symmetrically shaped case materials is welded to each other to form a case for a secondary battery, the flange 14 may be removed.

Because the case material 10 for a secondary battery is processed into an L-shape, a recessed portion (region A) may be created. Fracture of the material may occur within the recessed region, particularly at the boundary between a sidewall 16 of the recess 12 and the flange 14 and at a bent portion of the flange 14. These portions may be subjected to pressures in opposite directions by the die and the punch during material forming. The tensile strain of the material may increase due to the high pressure, making fracture more likely to occur. A region in which such fracture occurs is indicated by “B” in FIG. 2.

To prevent fracture in region B, the flange 14 may be omitted, and the sidewall 16 may be shortened to reduce tensile strain of the case material 10 for a secondary battery. However, this method may not be applied to cases requiring the flange 14. As an alternative, a high-cost material having excellent processability may be used for the case material 10. However, this has a drawback in that a high cost of the material increases a price of a product including the case material 10. Therefore, to address these issues, the present disclosure provides a secondary battery manufacturing apparatus 1 having an improved structure.

Referring back to FIG. 1, the secondary battery manufacturing apparatus 1 according to some embodiments of the present disclosure may broadly include an upper slide 3, a lower slide 5, and a mold 7. As described above, the secondary battery manufacturing apparatus 1 may be implemented as a press machine. The upper slide 3 may be operable to move upward or downward relative to the lower slide 5. The lower slide 5 may remain fixed in position. The press machine of the present disclosure may adopt the operating method and the detailed structure of a conventional press machine, and thus a detailed description thereof will be omitted.

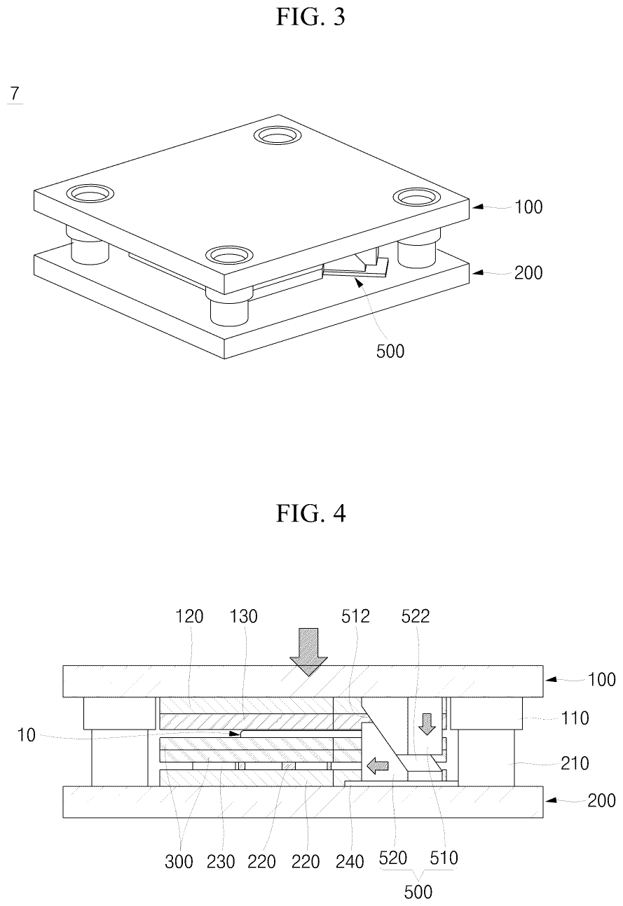

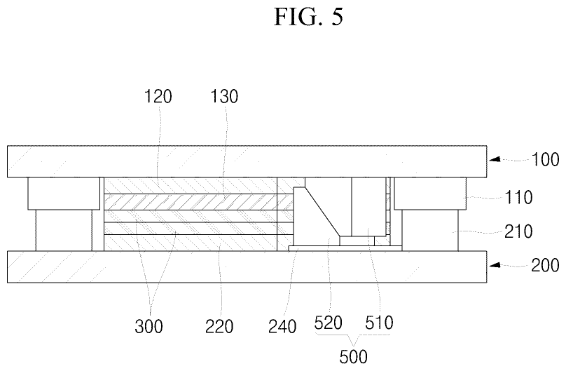

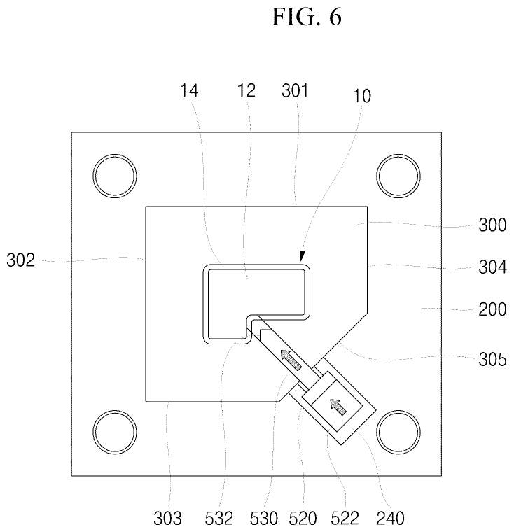

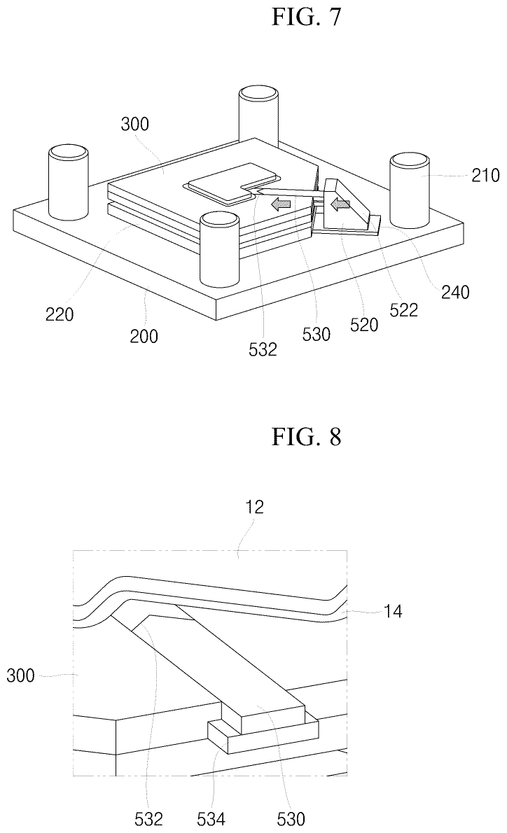

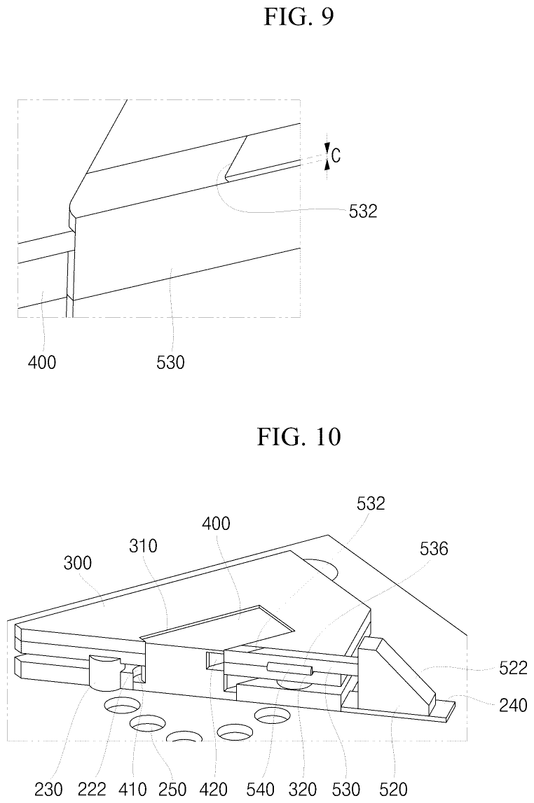

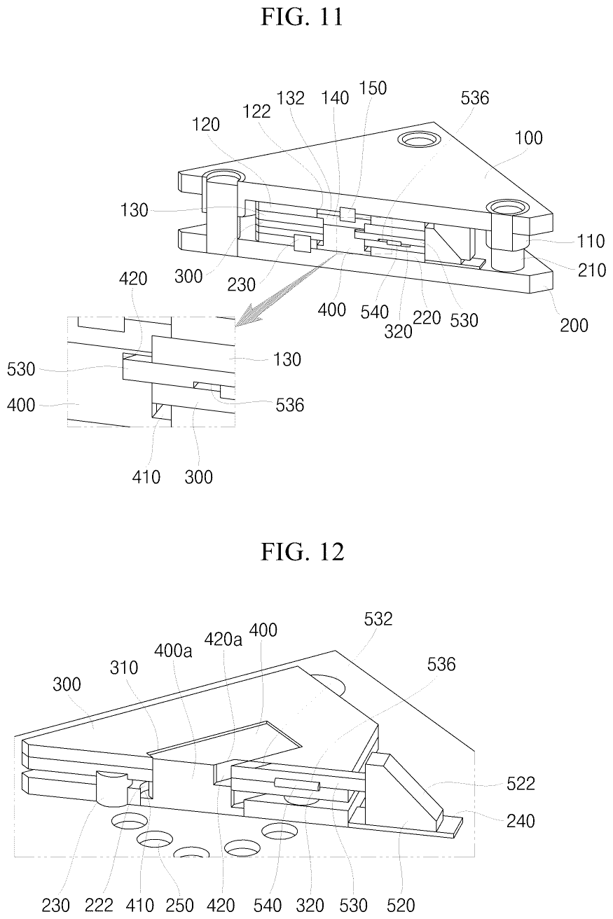

FIG. 3 is a perspective view showing an external appearance of the mold shown in FIG. 1 according to some embodiments of the present disclosure. FIG. 4 is a side view showing the mold of FIG. 3 before an upper mold of the mold is fully lowered according to some embodiments of the present disclosure. FIG. 5 is a side view showing the mold of FIG. 3 once an upper mold of the mold is fully lowered according to some embodiments of the present disclosure. FIG. 6 is a plan view of a lower mold according to some embodiments of the present disclosure. FIG. 7 is a perspective view of the lower mold shown in FIG. 6 according to some embodiments of the present disclosure. FIG. 8 is a rear perspective view of a sliding bar according to some embodiments of the present disclosure. FIG. 9 is a front perspective view of a sliding bar according to some embodiments of the present disclosure. FIG. 10 is a partial perspective view of a cam drive before the upper mold is fully lowered according to some embodiments of the present disclosure. FIG. 11 is a partial perspective view showing a cam drive when the upper mold is fully lowered according to some embodiments of the present disclosure.

Referring to FIGS. 3 to 11, the mold 7 may include an upper mold 100 and a lower mold 200. In some embodiments, the mold 7 may further include a blank holder 300, a punch 400, and a cam 500.

The upper mold 100 may be provided in the form of a rectangular plate when viewed from above and may have a predetermined thickness. The upper mold 100 may include an upper guide post 110, an upper holder 120, a die plate 130, a die pad 140, and a die pad spring 150. The upper mold 100 may be provided with a spring recess in which the die pad spring 150 is mounted. The upper mold 100, the upper guide post 110, the upper holder 120, and the die pad 140 may be formed of a rigid material including metal. The die plate 130 may be formed of a shock-absorbing material in order to mitigate impact generated during operation of the upper mold 100.

Referring to FIGS. 3 to 5 and 11, the upper guide post 110 may be provided in plural. Each of the upper guide posts 110 may be formed in a solid cylindrical shape or a hollow cylindrical shape. According to some embodiments, each of the upper guide posts 110 may be formed in a hollow cylindrical shape. Four upper guide posts 110 may be coupled to respective corners of the upper mold 100. In some embodiments, the upper guide posts 110 may be integrally formed with the upper mold 100. Lower guide posts 210 may be inserted into the respective upper guide posts 110. During downward movement of the upper mold 100, the upper guide posts 110 may contact and/or align with the lower guide posts 210 to ensure proper alignment of respective components.

Referring to FIGS. 4, 5, and 11, the upper holder 120 may be provided in a form of a rectangular plate when viewed from above and may have a predetermined thickness. However, the shape of the upper holder 120 is not limited to the aforementioned shape. The upper holder 120 may be smaller than the upper mold 100. The upper holder 120 may support the die plate 130 and the die pad 140. A pad receiving portion 122 may be formed through the central region of the upper holder 120. The die pad 140 may be inserted into the pad receiving portion 122. The pad receiving portion 122 may have a size and a shape corresponding to those of the die pad 140. Because the pad receiving portion 122 is in the form of a through-hole, a lower surface of the upper mold 100 may be exposed through the pad receiving portion 122. The die pad spring 150 may be mounted in the pad receiving portion 122. The die plate 130 may be provided on a lower surface of the upper holder 120.

Referring to FIGS. 4, 5, and 11, the die plate 130 may have a size and a shape corresponding to those of the upper holder 120. The die plate 130 may be provided in the form of a rectangular plate when viewed from above and may have a predetermined thickness. The upper surface of the die plate 130 may be coupled with or attached to the upper holder 120. During downward movement of the upper mold 100, the lower surface of the die plate 130 may come into contact with the blank holder 300. A pad hole 132 may be formed through the central region of the die plate 130. The die pad 140 and the punch 400 may be in close contact with each other within the pad hole 132. The pad hole 132 may be in communication with the pad receiving portion 122 described above. The pad hole 132 may be smaller than the pad receiving portion 122.

Referring to FIG. 11, the die pad 140 may be provided in the form of a plate having a predetermined thickness. The die pad 140 may press the case material 10 for a secondary battery, which is to be processed, from above. The shape of the die pad 140 may be determined according to the shape to be processed. In order to manufacture a case for a secondary battery having an L-shape when viewed from above, the die pad 140 may have an L-shaped lower surface when viewed from above. In some embodiments, the die pad 140 may have a shape in which an edge of a substantially upper region of the die pad 140 protrudes outward along a side surface of the die pad 140. A lower region of the die pad 140 may have a size and a shape corresponding to those of the pad hole 132 in the die plate 130. A portion of the die pad 140 that protrudes outward may be caught in the pad hole 132, which is smaller than the pad receiving portion 122, thereby preventing separation of the die pad 140. In some embodiments, the vertical height of the die pad 140 may be less than a sum of a height of the pad receiving portion 122 and a height of the pad hole 132. For example, the height of the upper region of the die pad 140 having a protruding edge may correspond to 50% of the height of the pad receiving portion 122. The height of the lower region of the die pad 140 may correspond to 50% of the height of the pad hole 132. The height of the die pad 140 may be varied within a range in which the die pad 140 is not exposed outside the pad hole 132 when the upper mold 100 is in a raised position. Thus, because a clearance space is defined inside the pad receiving portion 122 and the pad hole 132, the die pad 140 may ascend or descend within the pad receiving portion 122 and the pad hole 132. The die pad 140 may be elastically supported in the downward direction by the die pad spring 150 described above.

Referring to FIG. 11, the die pad spring 150 may be a spring configured to undergo compression and extension in the vertical direction. One end of the die pad spring 150 may be fixed to or inserted into the lower surface of the upper mold 100. The other end of the die pad spring 150 may be fixed to or inserted into an upper surface of the die pad 140. In a non-compressed state, the die pad spring 150 may serve to push the die pad 140 in the downward direction. The restoring force of the die pad spring 150 may act in the downward direction. If the punch 400 and the die pad 140 are engaged with each other, the die pad 140 may be raised by the punch 400, and the die pad spring 150 may be compressed. A compression direction of the die pad spring 150 may be the upward direction. If the punch 400 and the die pad 140 are disengaged from each other, a restoring force of the die pad spring 150 may cause the die pad 140 to descend to an original position of the die pad 140.

The upper mold 100 configured as described above may descend toward the lower mold 200, and, in conjunction with this movement, the blank holder 300, the punch 400, and the cam 500 of the lower mold 200 may be actuated.

Referring to FIGS. 3 to 7 and 11, the lower mold 200 may be provided in the form of a rectangular plate when viewed from above and may have a predetermined thickness. The lower mold 200 may include a lower guide post 210, a lower holder 220, a blank holder spring 230, a cam pad 240, and a spring recess 250. The lower mold 200, the lower guide post 210, and the lower holder 220 may be formed of a rigid material including metal. The cam pad 240 may be formed of a shock-absorbing material in order to mitigate impact generated during operation of the cam 500.

Referring to FIGS. 3 to 5 and 11, the lower guide post 210 may be provided in a plurality of lower guide posts 210. Each lower guide post 210 of the plurality of lower guide posts 210 may be formed in a solid cylindrical shape or a hollow cylindrical shape. According to some embodiments, each lower guide post 210 of the plurality of lower guide posts 210 may be formed in a solid cylindrical shape. Four lower guide posts 210 may be coupled to the respective corners of the lower mold 200. In some embodiments, the lower guide posts 210 may be integrally formed with the lower mold 200. The lower guide posts 210 may be inserted into respective upper guide posts 110. During downward movement of the upper mold 100, the lower guide posts 210 may connect and may align with the upper guide posts 110 to ensure proper alignment of respective components.

Referring to FIGS. 6, 7, 10, and 11, the lower holder 220 may be formed in a polyhedral shape having an operating surface at one corner. The lower holder 220 may be provided in the form of a rectangular plate when viewed from above and may have a predetermined thickness. A shape of the lower holder 220 may correspond to a shape of the blank holder 300 and may be used for operation of the cam 500. However, the shape of the lower holder 220 is not limited to the aforementioned polyhedral shape and/or the shape of the blank holder 300. The lower holder 220 may be smaller than the lower mold 200. The lower holder 220 may serve to support the blank holder 300 and the punch 400. A punch receiving portion 222 may be formed through the central region of the lower holder 220. The punch 400 may be inserted into the punch receiving portion 222. The punch receiving portion 222 may have a size and a shape corresponding to those of the punch 400. Because the punch receiving portion 222 is in the form of a through-hole, the upper surface of the lower mold 200 may be exposed through the punch receiving portion 222. The blank holder spring 230 may be spaced apart from the punch receiving portion 222. The cam pad 240 and the spring recess 250 may be provided on the upper surface of the lower holder 220.

Referring to FIGS. 4, 10, and 11, the blank holder spring 230 may be a spring configured to undergo compression and extension in a vertical direction. The blank holder spring 230 may be provided in a plurality of blank holder springs 230, and the blank holder springs 230 of the plurality of blank holder springs 230 may be spaced apart from each other at regular intervals. One end of the blank holder spring 230 may be fixed to or inserted into the spring recess 250. The other end of the blank holder spring 230 may be fixed to or inserted into a lower surface of the blank holder 300. In a non-compressed state, the blank holder spring 230 may serve to push the blank holder 300 in the upward direction. A restoring force of the blank holder spring 230 may act in the upward direction. As the upper mold 100 descends, the blank holder 300 may be lowered by the die plate 130, and the blank holder spring 230 may be compressed. A compression direction of the blank holder spring 230 may be the downward direction. As the upper mold 100 ascends, the restoring force of the blank holder spring 230 may cause the blank holder 300 to ascend to the original position of the blank holder 300. If the upper mold 100 is in a raised position, the blank holder 300 may be maintained in a state separated from the lower holder 220 by the blank holder spring 230.

Referring to FIGS. 4 to 7, the cam pad 240 may be provided in the form of a rectangular plate and may be formed of a shock-absorbing material. The cam pad 240 may be adjacent to or in close contact with the aforementioned operating surface of the lower holder 220. The cam pad 240 may support a lower cam 520 of the cam 500 from below. The lower cam 520 may be seated on the upper surface of the cam pad 240.

Referring to FIG. 10, the spring recess 250 may be recessed in the upper surface of the lower mold 200. The spring recess 250 may be provided in plural, and the number of spring recesses 250 may correspond to the number of blank holder springs 230. In some embodiments, the spring recesses 250 may be disposed in alignment with the blank holder springs 230. The blank holder springs 230 may be inserted into the spring recesses 250, and the blank holder 300 may be elastically supported by the blank holder springs 230.

Referring to FIGS. 4 to 7, 10, and 11, the blank holder 300 may be provided in the form of two plates having a predetermined thickness. The blank holder 300 may be provided in the form of two plates being attached or coupled to each other. The case material 10 for a secondary battery, which is to be processed, may be placed on the upper surface of the blank holder 300. The blank holder 300 may support the case material 10 for a secondary battery from below. The blank holder 300 may be provided in a form of a rectangular plate when viewed from above and may have an operating surface 305 at one corner. The blank holder 300 may be have a flat hexahedral shape having an operating surface 305 at one corner. As in FIG. 6, the blank holder 300 may include a first side surface 301, a second side surface 302, a third side surface 303, and a fourth side surface 304, which define four side surfaces. The operating surface 305 may be a side surface connecting the third side surface 303 and the fourth side surface 304 at an intermediate point. In some embodiments, the operating surface 305 may be a surface that is perpendicular to a moving direction of a sliding bar 530 of the cam 500 (i.e., a surface that is parallel to the operating direction of an upper cam). During manufacture of a case for a secondary battery, the case material 10 for a secondary battery may be disposed such that the recessed portion of the case material 10 faces the operating surface 305. In some embodiments, the blank holder 300 may include a punch hole 310 formed through the central region of the blank holder 300. The punch 400 may be inserted into the punch hole 310. The punch hole 310 may have a smaller size than the punch receiving portion 222 of the lower holder 220. Thus, the punch 400 may be caught in the punch hole 310 and may be prevented from being released outside. Although not shown in the drawings, a groove or a hole (referred to as a sliding groove for convenience) (see FIG. 10) into which the sliding bar 530 is inserted may be formed in the upper plate among the two plates of the blank holder 300. The sliding groove may be in communication with the operating surface. A return spring groove 320 may be formed in a longitudinal direction of the sliding bar 530 in an inner side of the sliding groove. When the blank holder 300 is not lowered by the upper mold 100, the punch 400 may be exposed through the punch hole 310. The punch 400 may be in a state of not protruding outward from the punch hole 310 (see FIG. 10). When the blank holder 300 is lowered, the punch 400 may protrude above the punch hole 310 through the punch hole 310. The protruding punch 400 may come into close contact with the die pad 140. Because the case material 10 for a secondary battery is placed on the blank holder 300, the punch 400 and the die pad 140 may come into close contact with each other with the case material 10 for a secondary battery interposed between the punch 400 and the die pad 140.

Referring to FIGS. 10 and 11, the punch 400 may press the case material 10 for a secondary battery, which is to be processed, from below. The punch 400 may be fixed to the upper surface of the lower mold 200. A shape of the punch 400 may be determined according to a shape suitable for processing with the punch 400. In order to manufacture a case for a secondary battery having an L-shape when viewed from above, the punch 400 may have an L-shaped upper surface when viewed from above. In some embodiments, a substantially upper region of the punch 400 may have a shape corresponding to a drawing region (e.g., the recess 12) of the case material 10 for a secondary battery. In some embodiments, the punch 400 may have a shape of which an edge of a substantially lower region of the punch 400 protrudes outward along a side surface of the punch 400 (hereinafter referred to as a protruding portion 410). An upper region of the punch 400 may have a size and a shape corresponding to those of the punch hole 310 in the blank holder 300. The protruding portion 410 of the punch 400 may be caught in the punch hole 310, which is smaller than the punch receiving portion 222, thereby preventing separation of the punch 400. In some embodiments, the punch 400 may include an insertion groove 420 formed in a portion of the side surface adjacent to the upper surface of the punch 400 so as to allow the sliding bar 530 to be inserted into the side surface. The insertion groove 420 may have a longitudinal-sectional shape that is substantially a U-shape rotated by about 90 degrees based on FIG. 10. If the blank holder 300 is in a raised position, a portion of the insertion groove 420 may be blocked by the blank holder 300. In some embodiments, a portion of the insertion groove 420 may be blocked by the sliding bar 530. The blank holder 300 may block a lower portion of the insertion groove 420, and the sliding bar 530 may block an upper portion of the insertion groove 420. The sliding bar 530 may be in a state of not being inserted into the insertion groove 420 (i.e., see FIG. 10). As the blank holder 300 descends, a position of the sliding bar 530 becomes aligned with a position of the insertion groove 420. The insertion groove 420 may be in communication with the sliding groove in the blank holder 300. Thus, the sliding bar 530 may be inserted into the insertion groove 420. As described above, the punch 400 may become exposed to the outside as the blank holder 300 descends. Although the punch 400 is fixed, the punch 400 may appear to ascend relative to the die pad 140. Thus, the die pad 140 may press the case material 10 for a secondary battery from above, and the punch 400 may press the case material 10 for a secondary battery from below. In conjunction with the operations of the die pad 140 and the punch 400, the cam 500 may operate so that the recessed region of the case material 10 for a secondary battery is not fractured.

FIG. 12 is a partial perspective view showing a pre-operation state of a lower mold and a cam drive according to some embodiments of the present disclosure.

In some embodiments, referring to FIG. 12, a punch 400a may have a different shape from the insertion groove 420 described above. An insertion groove 420a may have a longitudinal-sectional shape that is substantially an L-shape based on FIG. 12. The punch 400a shown in FIG. 12 may differ from the punch 400 of the above-described embodiment only in the shape of the insertion groove 420a, and may be identical in some or all other aspects.

Referring back to FIGS. 4 to 11, the cam 500 may include an upper cam 510, a lower cam 520, a sliding bar 530, and a return spring 540. The upper cam 510 and the lower cam 520 may have structures that are symmetrical to each other.

The upper cam 510 may be formed in a polyhedral shape. One end of the upper cam 510 may be coupled or attached to the upper mold 100, and the other end of the upper cam 510 may extend downward. The upper cam 510 may include a first operating surface 512. The first operating surface 512 may be inclined downward. The upper cam 510 may have a longitudinal-sectional shape that is substantially triangular. With reference to FIG. 5, the first operating surface 512 may be provided on the upper cam 510 at a position corresponding to approximately the 7 to 8 o'clock direction on a circular clock face. The upper cam 510 may have a shape of which a width of a longitudinal section of the upper cam 510 gradually decreases from an upper end of the upper cam 510 toward a lower end of the upper cam 510.

The lower cam 520 may be formed in a polyhedral shape. One end of the lower cam 520 may be seated on the cam pad 240 of the lower mold 200, and the other end of the lower cam 520 may extend upward. The lower cam 520 may be in a state of not being fixed to the upper side of the cam pad 240. The lower cam 520 may be connected to the sliding bar 530. The lower cam 520 may include a second operating surface 522. The second operating surface 522 may be inclined upward. The lower cam 520 may have a longitudinal-sectional shape that is substantially triangular. With reference to FIG. 5, the second operating surface 522 may be provided on the lower cam 520 at a position corresponding to approximately the 1 to 2 o'clock direction on a circular clock face. The lower cam 520 may have a shape of which a width of a longitudinal section of the lower cam 520 gradually decreases from a lower end of the lower cam 520 toward an upper end of the lower cam 520. The sliding bar 530 may be connected to a surface of the lower cam 520 that is opposite of the second operating surface 522.

Referring to FIGS. 4 to 7, the upper cam 510 may descend along with descent of the upper mold 100. An operating direction of the upper cam 510 is indicated by an arrow in the drawings. As the upper cam 510 descends, the first operating surface 512 may descend while remaining in contact with the second operating surface 522 of the lower cam 520. The first operating surface 512 may slide along the second operating surface 522, thereby pushing the second operating surface 522 toward the blank holder 300. Because the sliding bar 530 is connected to the lower cam 520, the sliding bar 530 may be moved toward the blank holder 300 by the lower cam 520. An operating direction of the lower cam 520 is indicated by an arrow in the drawings.

Referring to FIGS. 6 to 11, the sliding bar 530 may be formed in a substantially rectangular parallelepiped shape. One end of the sliding bar 530 may be fixed to the lower cam 520, and the other end of the sliding bar 530 may be disposed toward the blank holder 300. The sliding bar 530 may include a stepped portion 532 and a side protruding portion 534.

The sliding bar 530 may have a longitudinal-sectional shape that is substantially an inverted T shape. In some embodiments, the sliding bar 530 may include a side protruding portion 534 that protrudes in a direction perpendicular to the longitudinal direction. The side protruding portion 534 may protrude outward from a lower portion of a side surface of the sliding bar 530 with respect to the longitudinal section of the sliding bar 530 (see FIG. 8). Because the above-described sliding groove is formed in the blank holder 300, the sliding bar 530 may be inserted into the sliding groove. The sliding groove may be formed in a shape corresponding to the shape of the sliding bar 530. Because the side protruding portion 534 is inserted into the sliding groove, the sliding bar 530 may be prevented from being separated upward from the sliding groove. The sliding bar 530 may move linearly within the sliding groove along with movement of the lower cam 520. A sliding direction of the sliding bar 530 is indicated by an arrow in the drawings. The sliding bar 530 may linearly move toward the center of the blank holder 300 and in the opposite direction. After the sliding bar 530 is fully moved toward the blank holder 300, an end of the sliding bar 530 may be located at a position corresponding to the recessed region of the case material 10 for a secondary battery.

In some embodiments, the other end of the sliding bar 530 may have a substantially V-shape when viewed from above. The V-shape may correspond to the recessed portion of the case material 10 for a secondary battery. A shape of the other end of the sliding bar 530 may be varied depending on a shape of the material to be processed. The stepped portion 532 may be formed on an upper surface of the other end of the sliding bar 530.

The stepped portion 532 may be a portion of the upper surface of the sliding bar 530 that is recessed to form a step. A region from the stepped portion 532 to the other end of the sliding bar 530 may be provided at a height relative to the upper surface of another region. The region from the stepped portion 532 to the other end of the sliding bar 530 may have a width greater than a width of the material to be processed (e.g., a width of the flange 14 of the case material 10 for a secondary battery). The stepped portion 532 may have a V-shape corresponding to the V-shaped end of the sliding bar 530. The stepped portion 532 may have a height difference C from the upper surface of the sliding bar 530, excluding a predetermined region of the end. The height difference C may correspond to the thickness of the case material 10 for a secondary battery. For example, the height difference C may be about 0.1 mm. As the sliding bar 530 moves toward the blank holder 300 and as the end portion of the sliding bar 530 is inserted into the punch 400, the stepped portion 532 may come into contact with the end of the case material 10 for a secondary battery (more specifically, the outer side of the flange). As shown in FIG. 9, the case material 10 for a secondary battery may be placed on a region from the stepped portion 532 to the V-shaped end of the sliding bar 530 (i.e., an upper surface of the left region of the sliding bar shown in FIG. 9), and the stepped portion 532 may come into contact with the end of the case material 10 for a secondary battery. Because the sliding bar 530 is pressed toward the blank holder 300 by the lower cam 520, the stepped portion 532 may press the case material 10 for a secondary battery. The position of the sliding bar 530 may correspond to the recessed region of the case material 10 for a secondary battery. The stepped portion 532 may come into contact with the outer side of the flange 14 of the case material 10 for a secondary battery. Thus, the stepped portion 532 may press the recessed region of the case material 10 for a secondary battery toward the recess 12. The return spring 540 may be mounted on a side surface or a lower surface of the sliding bar 530 spaced apart from the stepped portion 532. To this end, a spring groove 536 may be formed in the sliding bar 530.

The return spring 540 may be a spring configured to undergo compression and extension in the longitudinal direction of the sliding bar 530. One end of the return spring 540 may be fixed to the sliding bar 530, and the other end of the return spring 540 may be fixed to the blank holder 300. As the lower cam 520 is moved and the sliding bar 530 is inserted into the punch 400, the return spring 540 may expand. If the force applied to the lower cam 520 is removed, the sliding bar 530 may return to an original position of the sliding bar 530 due to a restoring force of the return spring 540. The lower cam 520 connected to the sliding bar 530 may also return to an original position of the lower cam 520.

First, the case material 10 for a secondary battery may be placed on the blank holder 300. As the upper mold 100 descends, the lower guide post 210 may be inserted into the upper guide post 110. The upper holder 120 and the die plate 130 may descend together. The die plate 130 may come into contact with the blank holder 300 and may press the blank holder 300 downward. As the blank holder 300 moves downward, the punch 400 may protrude upward through the punch hole 310. Although the punch 400 is fixed, the descent of the upper mold 100 may cause the punch 400 to appear to ascend relative to the upper mold 100. The protruding upper surface of the punch 400 may support the case material 10 for a secondary battery from below. The lowered die pad 140 may press the case material 10 for a secondary battery from above. The region in which the punch 400 and the die pad 140 are engaged with each other may be located inside the pad hole 132 in the die plate 130. As the punch 400 and the die pad 140 are engaged with each other, the case material 10 for a secondary battery may be processed into a final shape according to the shapes of the punch 400 and the die pad 140. The case material 10 for a secondary battery may be deformed into a shape having the recess 12 and the flange 14. As the punch 400 and the die pad 140 are engaged with each other, the die pad spring 150 that supports the die pad 140 may be compressed. The blank holder spring 230 that supports the blank holder 300 may also be compressed.

As the upper mold 100 descends, the upper cam 510 may also descend. The first operating surface 512 of the upper cam 510 may slide along the second operating surface 522 of the lower cam 520, thereby pressing the lower cam 520. The lower cam 520 may be pushed toward the blank holder 300 by the upper cam 510. Because the sliding bar 530 is connected to the surface of the lower cam 520 that is opposite the second operating surface 522, the sliding bar 530 may also move toward the blank holder 300.

As the upper mold 100 descends, the blank holder 300 may also descend, thereby opening the insertion groove 420 in the punch 400 that has been blocked. As the sliding bar 530 moves toward the blank holder 300, the end of the sliding bar 530 may be inserted into the insertion groove 420. The end of the sliding bar 530 may enter below the flange 14 of the case material 10 for a secondary battery in a movement direction of the sliding bar 530. A region from the end of the sliding bar 530 to the stepped portion 532 may have a height difference, corresponding to the thickness of the case material 10 for a secondary battery, from the upper surface of the sliding bar 530. Thus, an end of the sliding bar 530 entering below the flange 14 may be caught by the stepped portion 532. Because the sliding bar 530 is continuously pushed toward the punch 400 by pressure applied by the upper cam 510, the stepped portion 532 may also push the outer side of the flange 14. Thus, the outer side of the flange 14 may be pressed toward the recess 12. Pressing on the flange 14 by the stepped portion 532 may occur simultaneously with deformation of the case material 10 for a secondary battery by the punch 400 and the die pad 140. Thus, even when tensile stress increases in the recessed portion during processing of the case material 10 for a secondary battery, the flange 14 may be pressed toward the recess 12, thereby preventing fracture of the material. Because the flange 14 is pressed in a direction opposite the tensile direction, the material of the recessed region may be prevented from fracturing. Strictly speaking, because the flange is formed after the material is completely formed, the portion that is actually pressed by the sliding bar may be the edge of the recessed region of the material. However, for ease of understanding, it has been described that the sliding bar presses the flange.

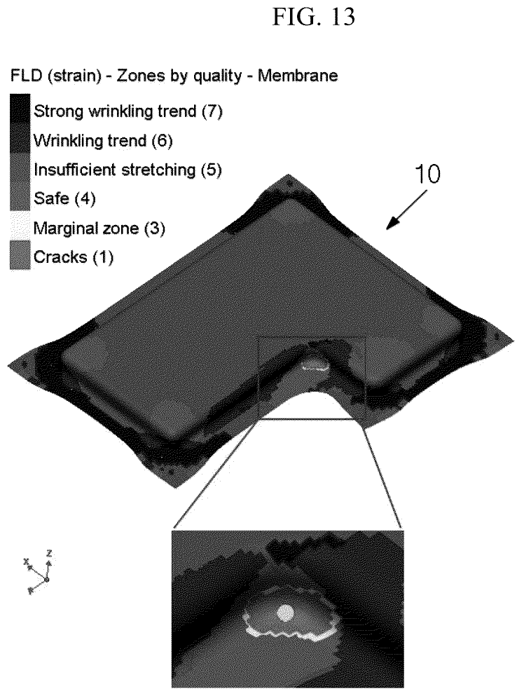

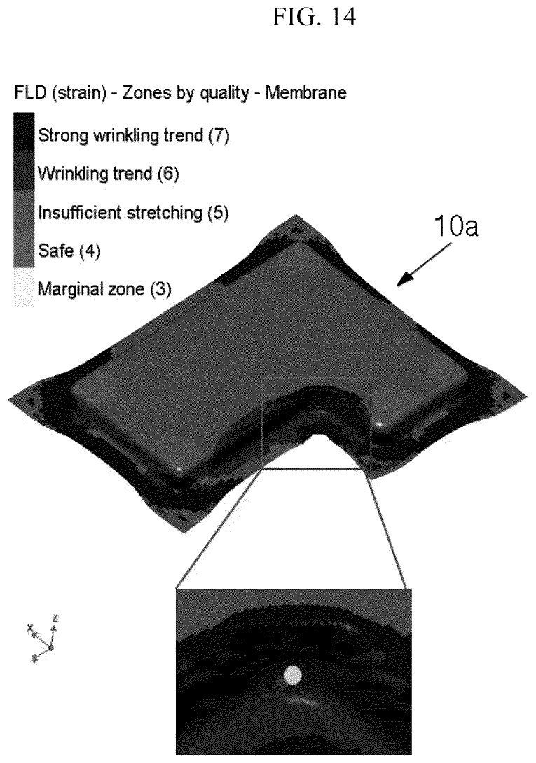

FIG. 13 is a view showing a damaged state of a case material for a secondary battery manufactured by a conventional manufacturing apparatus. FIG. 14 is a view showing a state of a case material for a secondary battery manufactured by the manufacturing apparatus according to some embodiments of the present disclosure.

FIG. 13 shows analysis results after forming of the case material 10 for a secondary battery manufactured by a conventional manufacturing apparatus not including the above-described cam 500. Referring to FIG. 13, the recessed portion of the material exhibits the highest tensile strain due to the pressure applied to the recessed portion of the material. Furthermore, cracking occurs between the recess and the flange within the recessed region and within the flange region adjacent to the recess.

FIG. 14 is a view showing a case material for a secondary battery manufactured by the manufacturing apparatus according to some embodiments of the present disclosure.

Referring to FIG. 14, it may be seen that the case material for a secondary battery, which is manufactured by the manufacturing apparatus according to some embodiments of the present disclosure, does not exhibit cracking in the same regions as in FIG. 13 because the flange 14 is pressed in a direction opposite of a drawing direction of the material by the sliding bar 530 of the cam 500. As a result, the case material for a secondary battery may be formed while preventing excessive tensile deformation of the case material for a secondary battery, thereby preventing breakage of the case material for a secondary battery.

As is apparent from the above description, according to some embodiments of the present disclosure, a case for a secondary battery having a recessed portion, which is highly susceptible to breakage during press forming, may be formed without breakage. Thus, processability of the material may be improved and product defects may be prevented. Furthermore, even without using expensive materials having excellent processability, the case may be formed without breakage. As a result, manufacturing costs may be reduced.

However, aspects and features of the present disclosure are not limited to those described above, and other aspects and features not mentioned will be clearly understood by a person skilled in the art from the detailed description, described below.

While the disclosure has been described in connection with only some embodiments and/or drawings, the disclosure is not limited thereto, and it should be understood that various changes and modifications may be made by those skilled in the art.

What is claimed is:

1. A secondary battery manufacturing apparatus configured to draw a case material for a secondary battery, the case material having a recessed region, the secondary battery manufacturing apparatus comprising:
an upper mold comprising a die pad configured to press the case material from above;
a lower mold comprising a punch configured to press the case material from below;
a blank holder mounted to the lower mold, the blank holder including a punch hole formed through the blank holder to receive the punch, the blank holder being configured to support the case material from below the case material; and
a cam comprising:
an upper cam mounted to the upper mold and having a first operating surface;
a lower cam seated on the lower mold and having a second operating surface in contact with the first operating surface; and
a sliding bar connected to the lower cam and configured to be linearly moved in a direction perpendicular to an operating direction of the upper cam by the lower cam.

2. The secondary battery manufacturing apparatus as claimed in claim 1, wherein the sliding bar comprises a stepped portion provided on a surface adjacent to an end of the sliding bar.

3. The secondary battery manufacturing apparatus as claimed in claim 2, wherein the stepped portion is provided on an upper surface of the sliding bar and has a height difference C from the upper surface.

4. The secondary battery manufacturing apparatus as claimed in claim 3, wherein the height difference C of the stepped portion from the upper surface corresponds to a thickness of the case material.

5. The secondary battery manufacturing apparatus as claimed in claim 2, wherein the blank holder comprises a sliding groove, which is configured so that the sliding bar is able to be inserted into the sliding groove of the blank holder.

6. The secondary battery manufacturing apparatus as claimed in claim 5, wherein the punch comprises an insertion groove, which is configured so that the sliding bar is able to be inserted into the insertion groove of the punch.

7. The secondary battery manufacturing apparatus as claimed in claim 1, wherein the lower mold further comprises a lower holder, which is configured so that the punch is able to be inserted in the lower holder, and
wherein the punch is mounted to the lower holder and has an upper portion inserted into the punch hole formed through the blank holder.

8. The secondary battery manufacturing apparatus as claimed in claim 1, wherein the lower mold further comprises a plurality of blank holder springs configured to elastically support the blank holder from below the blank holder.

9. The secondary battery manufacturing apparatus as claimed in claim 1, wherein the blank holder is configured to be pressed and lowered as the upper mold descends.

10. The secondary battery manufacturing apparatus as claimed in claim 1, wherein an upper portion of the punch is configured to protrude upward through the punch hole as the blank holder descends.

11. The secondary battery manufacturing apparatus as claimed in claim 6, wherein the insertion groove in the punch and the sliding groove in the blank holder are configured to communicate with each other as the blank holder descends.

12. The secondary battery manufacturing apparatus as claimed in claim 5, wherein the cam further comprises a return spring having an end fixed to an inner side of the sliding groove in the blank holder and having an end coupled to the sliding bar.

13. The secondary battery manufacturing apparatus as claimed in claim 12, wherein the return spring is configured to expand as the sliding bar moves toward the blank holder and is configured to exert a restoring force in a direction away from the blank holder.

14. The secondary battery manufacturing apparatus as claimed in claim 6, upon the upper mold being fully lowered, the case material is disposed on the blank holder and the case material is drawn between the punch and the die pad to form a recess and a flange.

15. The secondary battery manufacturing apparatus as claimed in claim 6, upon the upper mold being fully lowered, the upper cam presses on the lower cam such that the sliding bar is fully inserted into the insertion groove in the punch.

16. The secondary battery manufacturing apparatus as claimed in claim 14, upon the sliding bar being fully inserted into the insertion groove in the punch, the stepped portion is in contact with the flange of the case material and is pressing on the flange.

17. The secondary battery manufacturing apparatus as claimed in claim 14, wherein the flange being pressed by the stepped portion delimits the recessed region of the case material.

18. The secondary battery manufacturing apparatus as claimed in claim 5, wherein the blank holder further comprises an operating surface in a direction facing the lower cam, the operating surface corresponding with a plane perpendicular to a sliding direction of the sliding bar.

19. The secondary battery manufacturing apparatus as claimed in claim 18, wherein, in the blank holder, the sliding groove is in communication with the operating surface.

20. The secondary battery manufacturing apparatus as claimed in claim 1, wherein the upper mold further comprises:
an upper holder comprising a pad receiving portion receiving the die pad; and
a die plate mounted under the upper holder, the die plate comprising a pad hole configured so that the die pad is able to be inserted in the pad hole,
wherein the die pad and the punch are fully engaged with each other inside the pad hole.
